(19) United States
(12) Patent Application Publication
(10) Pub. No.: US 2022/0088849 A1
(43) Pub. Date: Mar. 24, 2022

(54) STACKED WORKPIECE

(71) Applicant: HONDA MOTOR CO., LTD., Tokyo (JP)

(72) Inventors: Akira Taguchi, Tochigi (JP); Hiroaki Iwanishi, Tochigi (JP); Michinobu Sato, Tochigi (JP); Hikaru Kurokawa, Tochigi (JP); Takashi Iino, Toshigi (JP); Yusuke Kato, Tochigi (JP); Takashi Abe, Tochigi (JP)

(21) Appl. No.: 17/424,421

(22) PCT Filed: Oct. 30, 2019
(86) PCT No.: PCT/JP2019/042642

§ 371 Date: Jul. 20, 2021

(30) Foreign Application Priority Data
Jan. 23, 2019 (JP) 2019-009245

(51) Int. Cl. B29C 51/10; B29C 51/12; B29C 65/48; B32B 1/04; B32B 3/02

(52) U.S. Cl. CPC B29C 51/10; B29C 51/12; B32B 3/02; B32B 1/04; B29C 65/48

(57) ABSTRACT

A stacked workpiece in which a sheet material can be more firmly attached to a workpiece body than in the related art is provided.

A stacked workpiece (40) includes a workpiece body (42), and a sheet material (44) stacked on the workpiece body (42). In the workpiece body (42), a workpiece-side protruding portion (42a) that is placed at least in a part of a peripheral portion of the stacked sheet material (44) and that protrudes toward a side of the sheet material (44) is provided, and a thinly-crushed compression portion (44a) is formed in a portion of the sheet material (44) stacked on the workpiece-side protruding portion (42a).

### TECHNICAL FIELD

The present invention relates to a stacked workpiece in which a sheet material is stacked on a workpiece body.

### BACKGROUND ART

Conventionally, a stacked workpiece molding device that molds a stacked workpiece, which includes a workpiece body and a sheet material stacked on the workpiece body, by using a first mold that sucks and holds the workpiece body has been known (see, for example, Japanese Patent Application Laid-Open No. 7-24909).

In Patent Literature 1, a clearance recess portion formed in a central portion of a workpiece body is closed by a shutter in order to prevent a sheet material from being pulled into and broken by the clearance recess portion.

Also, since a degree of freedom in layout of a workpiece body is limited when a shutter that covers a clearance recess portion is provided, what is provided with a suction device that is placed in a clearance recess portion formed in a central portion of a workpiece body and that sucks a sheet material in a direction away from the workpiece body has been also known (see, for example, Japanese Patent Application Laid-Open No. 2000-218688).

### CITATION LIST

### Patent Literature

Patent Literature 1: Japanese Patent Application Laid-Open No. 7-24909

Patent Literature 2: Japanese Patent Application Laid-Open No. 2000-218688

### SUMMARY OF INVENTION

### Technical Problem

In a stacked workpiece molding device of Patent Literature 1, in a case where a second mold having, on an inner surface, a pattern that can be transferred to a surface of a sheet material is used, it is conceivable that fluid such as air is ejected from the second mold in such a manner as to make it easier for the sheet material to peel off from the second mold when a first mold that sucks a workpiece body and the second mold are made to overlap with each other kind the sheet material is attached to the workpiece body after the sheet material is sucked by the second mold and the pattern is transferred thereto.

In this case, unlike Patent Literature 1, it is not possible to provide a suction device that is placed in a clearance recess portion in a central portion of the workpiece body and that sucks the sheet material in a direction away from the workpiece body. Thus, in order to improve a degree of freedom in layout of the workpiece body, it is conceivable to arrange nesting in the clearance recess portion.

Then, the sheet material is required to be firmly attached to the workpiece body.

An object of the present invention is to provide a stacked workpiece in which a sheet material can be more firmly attached to a workpiece body than in the related art.

### Solution to Problem

In order to achieve the above object, the present invention is
a stacked workpiece including
a workpiece body, and
a sheet material stacked on the workpiece body, wherein
a compression portion crushed in a thickness direction is formed in at least a part of a peripheral portion of the sheet material.

According to the present invention, since the compression portion is formed in at least a part of the peripheral portion of the sheet material by a workpiece-side protruding portion, the sheet material can be more firmly attached to the workpiece body than in the related art.

Also, it is preferable in the present invention that a workpiece-side protruding portion that protrudes toward a side of the sheet material and that forms the compression portion is provided in the workpiece body, and a protrusion amount of the workpiece-side protruding portion is set to be smaller than a thickness of the sheet material. According to such a configuration, since the protrusion amount of the workpiece-side protruding portion is set to be smaller than the wall thickness of the sheet material, the workpiece-side protruding portion is hidden by the sheet material. Thus, it is possible to prevent a rise of the sheet material due to the workpiece-side protruding portion and to improve appearance.

### BRIEF DESCRIPTION OF DRAWINGS

FIG. 1 is a view for schematically describing a stacked workpiece of an embodiment of the present invention.

FIG. 2 is a view for describing a first mold and a workpiece body of the present embodiment.

FIG. 3 is a view for describing a through hole of the present embodiment in an enlarged manner.

FIG. 4 is a view for describing suction force in a bonding process of the present embodiment.

FIG. 5 is a view for describing a workpiece-side protruding portion and a compression portion of the present embodiment.

FIG. 6 is a view for schematically describing a shutter device as a comparative example.

FIG. 7 is a view for schematically describing a stacked workpiece of another embodiment of the present invention.

### DESCRIPTION OF EMBODIMENTS

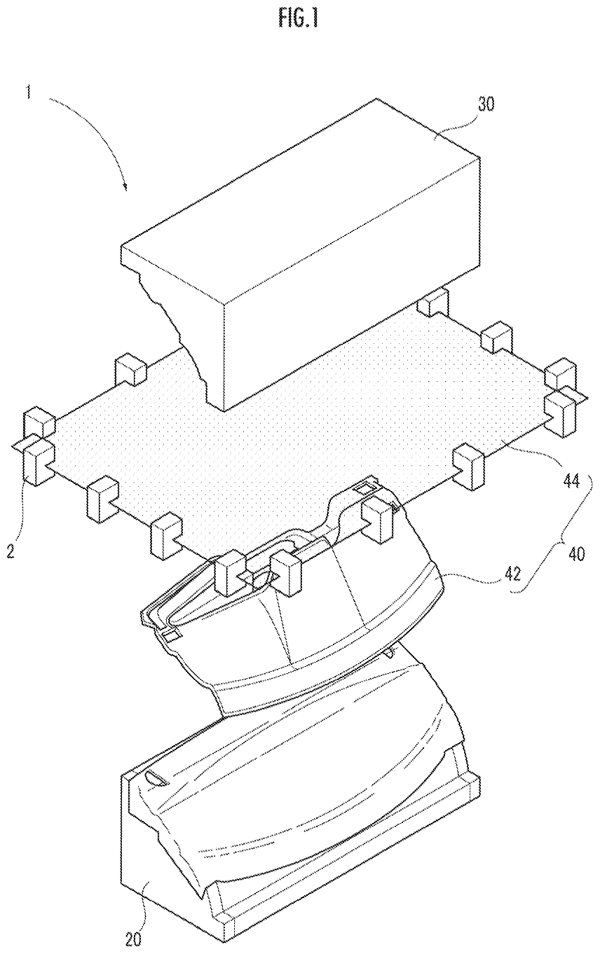

An embodiment of a stacked workpiece and a stacked workpiece molding device of the present invention will be described with reference to the drawings. Referring to FIG. 1, a stacked workpiece molding device 1 of the present embodiment includes a first mold 20 and a second mold 30. A stacked workpiece 40 such as an instrument panel molded by the stacked workpiece molding device 1 includes a workpiece body 42, and a sheet material 44 stacked on the workpiece body 42.

The stacked workpiece molding device 1 includes a plurality of clamps 2 that grips a periphery of the sheet material 44.

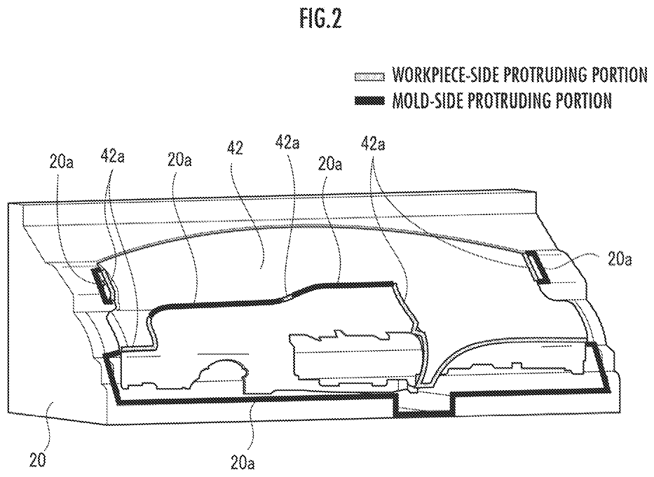

A state in which the workpiece body 42 is placed on the first mold 20 is illustrated in FIG. 2.

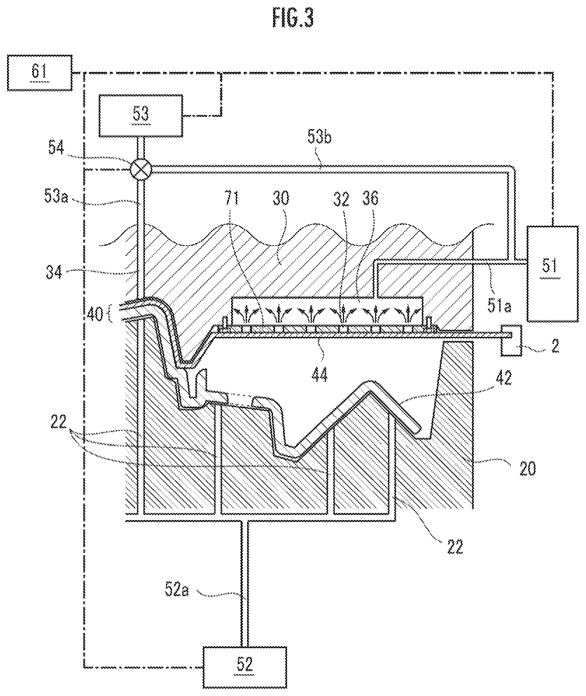

As illustrated in FIG. 3, a plurality of suction holes 22 opened to a placement surface on which the workpiece body 42 is placed is provided in the first mold 20. In the inner surface of the second mold 30, a pattern which is formed of a recess/protrusion such as an embossment or matt finished surface and which is to be transferred to a surface of the sheet material 44 is formed.

A plurality of through holes 32 penetrating in such a manner as to be opened to a position of a periphery of the workpiece body 42 when the second mold 30 is overlapped with the first mold 20 with the workpiece body 42 and the sheet material 44 interposed therebetween is provided in the second mold 30. A plate 71 is provided in such a manner as to cover an opening of a recessed portion 36 formed in the inner surface of the second mold 30, and the through holes 32 of the present embodiment are holes drilled in this plate 71. Note that the through holes 32 are not limited to the holes in the plate 71, and through holes may be pores included in a porous member embedded in the recessed portion 36, for example.

Also, a plurality of ejection holes 34 penetrating in such a manner as to be opened to a position of a central portion of the workpiece body 42 which portion is at portion excluding the periphery of the workpiece body 42 is provided in the second mold 30.

A first suction device 51 to suck the sheet material 44 is connected to the through holes 32 via a first connection pipe 51a. A second suction device 52 to suck the workpiece body 42 is connected to the suction holes 22 via a second connection pipe 52a. A gas supply device 53 that supplies gas such us air is connected to the ejection holes 34 via a third connection pipe 53a.

A bypass 53b is connected to the first connection pipe 51a and the third connection pipe 53a. Allow channel switching valve 54 is provided in a connection portion between the third connection pipe 53a and the bypass 53b. The flow channel switching valve 54 is configured to be switchable between two states that are an “ejection-enabled state” in which the gas supply device 53 is connected to the ejection holes 34 via the third connection pipe 53a and connection between the ejection holes 34 and the first suction device 51 via the bypass 53b is disconnected, and a “suction-enabled state” in which the first suction device 51 is connected to the ejection holes 34 via the third connection pipe 53a, the bypass 53b, and the first connection pipe 51a and connection between the ejection holes 34 and the gas supply device 53 is disconnected.

Also, referring to FIG. 2, in the first mold 20 and the workpiece body 42, a mold side protruding portion 20a and a workpiece-side protruding portion 42a protruding toward the second mold 30 are respectively provided in such a manner as to surround the plurality of through holes 32 and to extend along an outer edge of a bonded region of the sheet material 44.

When it is assumed that the mold-side protruding portion 20a and the workpiece-side protruding portion 42a are not provided, in a case where gas is supplied from the gas supply device 53 to the surface of the sheet material 44 via the ejection holes 34 and the sheet material 44 is peeled off from the second mold 10 in a bonding process of bonding the sheet material 44 to the workpiece body 42, sucking performance of the first suction device 51 with respect to the sheet material 44 is deteriorated when the gas supplied to the surface of the sheet material 44 flows directly to the through holes 32 and is sucked by the first suction device 51.

Thus, as described above, the mold-side protruding portion 20a and the workpiece-side protruding portion 42a are provided in such a manner as to surround the through holes 32 in the present embodiment, whereby it is possible to suppress or prevent the gas supplied from the gas supply device 53 to the surface of the sheet material 44 from flowing to the through holes 32, and to suppress or prevent deterioration in the sucking performance of the first suction device 51 with respect to the sheet material 44. Note that instead of the mold-side protruding portion 20a and the workpiece-side protruding portion 42a, a mold-side protruding portion may be provided in the second mold 30.

The stacked workpiece molding device 1 includes a control unit 61 that controls the first suction device 51, the second suction device 52, the gas supply device 53, and the flow channel switching valve 54. The control unit 61 is an electronic control unit including a CPU, a memory, and the like, and controls the first suction device 51, the second suction device 52, the gas supply device 53, and the flow channel switching valve 54 by executing a control program held in a storage unit such as a memory by the CPU and transmitting an instruction signal.

Next, a stacked workpiece molding method using the stacked workpiece molding device 1 will be described.

First, the first mold 20 and the second mold 30 are brought into an opened state, and the workpiece body 42 is placed on the first mold 20. Then, the sheet material 44 gripped by the clamps 2 is arranged between the workpiece body 42 and the second mold 30. Then, the first mold 20 and the second mold 30 are brought closer to each other and brought into a closed state.

Then, the control unit 61 switches the flow channel switching valve 54 to the “suction-enabled state” (state in which the first suction device 51 is connected to the ejection holes 34 via the third connection pipe 53a, the bypass 53b, and the first connection pipe 51a and the connection between the ejection holes 34 and the gas supply device 53 is disconnected), sucks the sheet material 44 with the first suction device 51 via the through holes 32 and the ejection holes 34, and causes the sheet material to be attached to the inner surface of the second mold 30. Thus, the pattern formed in the inner surface of the second mold 30 can be transferred to a surface of the sheet material 44 (transfer process).

Then, in a state in which an adhesive is applied to the workpiece body 42 or the sheet material 44, the material 44 is pressed against the workpiece body 42 and is bonded by suction force of the second suction device 52 (bonding process).

Here, the sheet material 44 is not bonded to the entire surface of the workpiece body 42, but is bonded only to a portion exposed in assembly of an automobile or the like and is not bonded to a portion such as a periphery hidden by another component in the assembly in order to prevent assembly failure. Only the bonded portion is left and cut, and the non-bonded portion is discarded.

Then, in the bonding process, the control unit 61 switches the flow channel switching valve 54 to the “ejection-enabled state” (state in which the gas supply device 53 is connected to the ejection holes 34 via the third connection pipe 53a and the connection between the ejection holes 34 and the first suction device 51 via the bypass 53b is disconnected), and supplies gas between the sheet material 44 and the second mold 30 by the gas supply device 53 via the ejection holes 34 in such a manner that the sheet material 44 is peeled off from the second mold 30.

Also, with the first suction device 51, the control unit 61 sticks a portion of the sheet material 44, which portion is not bonded to the work piece body 42, to the second mold 30 via the through holes 32.

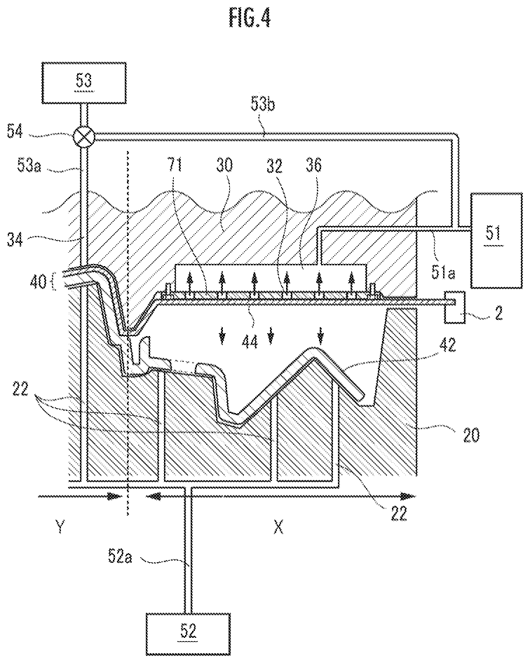

Here, the control unit 61 sets suction force of the first suction device 51 and the second suction device 52 in such a manner that the suction force to suck the sheet material 44 from the through holes 32 becomes stronger than the suction force to suck the workpiece body 42 from the suction holes 22 as indicated by a non-bonded region X in FIG. 4. When the suction force is set in such a manner, the sheet material 44 in the non-bonded portion can be appropriately attracted to the second mold 30.

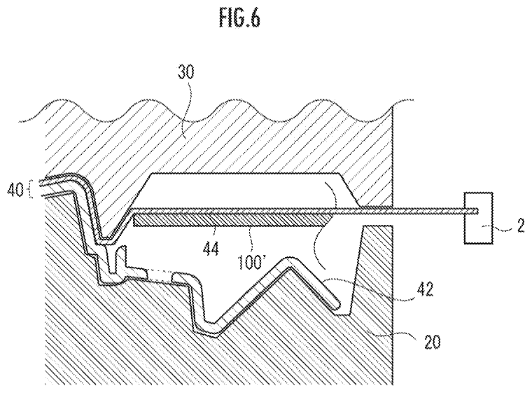

In such a manner, since the non-bonded portion placed in the periphery of the workpiece body 42 is sucked by the first suction device 51 via the through holes 32, it is not necessary to provide a shutter device 100′ that prevents bonding of the sheet material 44 in the periphery of the workpiece body 42 unlike a comparative example illustrated in FIG. 6. Thus, it is not necessary to arrange a clamp outside the shutter device 100 such a manner as to avoid the shutter device 100′ and to prepare a wide sheet material 44, whereby it is possible to reduce an amount of a waste portion of the sheet material 44 and to suppress a manufacturing cost of the stacked workpiece 40.

Also, when it is assumed that the mold-side protruding portion 20a and the workpiece-side protruding portion 42a are not provided, in a case where gas is supplied from the gas supply device 53 to the surface of the sheet material 44 via the ejection holes 34 and the sheet material 44 is peeled off from the second mold 30 in the bonding process of bonding the sheet material 44 to the workpiece body 42, sucking performance of the first suction device 51 with respect to the sheet material 44 is deteriorated when the gas supplied to the surface of the sheet material 44 flows directly to the through holes 32 and is sucked by the first suction device 51.

Thus, as described above, the mold side protruding pardon 20a and the workpiece-side protruding portion 42a are provided in such a manner as to surround the through holes 32 in the present embodiment, whereby it is possible to suppress or prevent the gas supplied from the gas supply device 53 to the surface of the sheet material 44 from flowing to the through holes 32, and to suppress or prevent deterioration in the sucking performance of the first suction device 51 with respect to the sheet material 44. Note that instead of the mold-side protruding portion 20a and the workpiece-side protruding portion 42a, a mold-side protruding portion may be provided in the second mold 30.

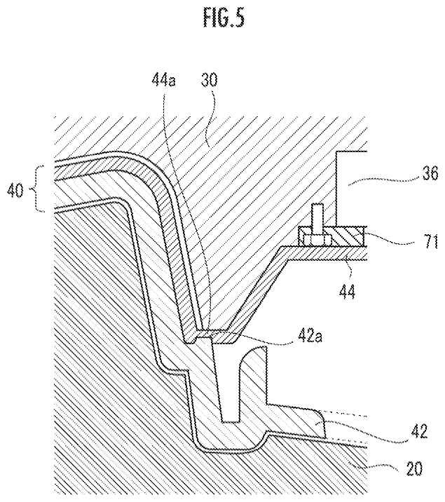

According to the stacked workpiece 40 of the present embodiment, as illustrated in FIG. 5, a space between the workpiece-side protruding portion 42a and the second mold 30 becomes narrow due to the workpiece-side protruding portion 42a, and a compression portion 44a sandwiched and thinly crushed between the workpiece-side protruding portion 42a and the second mold 30 is formed in at least a part of the peripheral portion of the sheet material 44 (portion where the workpiece-side protruding portion 42a is provided). Thus, according to the stacked workpiece 40 of the present embodiment, the sheet material 44 can be more firmly attached to the workpiece body 42 than in the related art. Note that in the present embodiment, the workpiece-side protruding portion 42a provided only in a part of the peripheral portion of the workpiece body 42 has been described. However, a workpiece-side protruding portion of the present invention may be provided in an entire peripheral portion of a workpiece body.

Also, as illustrated in FIG. 5, in the stacked workpiece 40 of the present embodiment, a protrusion amount of the workpiece-side protruding portion 42a is set to be smaller than a wall thickness of the sheet material 44. With such a configuration, the workpiece-side protruding portion 42a is hidden by the sheet material 44 and the surface of the sheet material 44 can be prevent from being raised by the workpiece-side protruding portion 42a. Thus, appearance of the stacked workpiece 40 can be improved.

Note that in the present embodiment, the description has been made by utilization of the workpiece-side protruding portion 42a having the protrusion amount set to be smaller than the wall thickness of the sheet material 44. However, a stacked workpiece of the present invention is not limited to this, and it is only necessary that a workpiece-side protruding portion and a compression portion are formed. Even when a protrusion amount of a workpiece-side protruding portion is set to be larger than a wall thickness of a sheet material, an effect of the present invention that “a sheet material 44 can be firmly attached to a workpiece body 42” can be acquired by a compression portion.

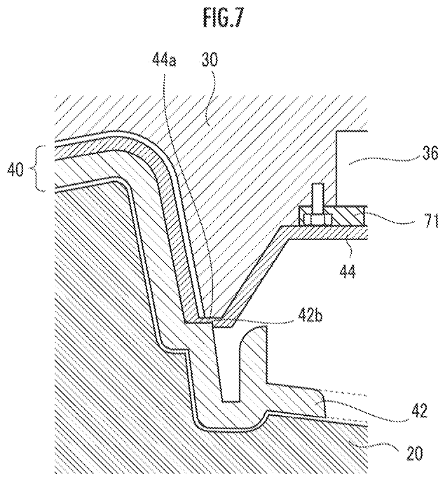

Also, as illustrated in FIG. 7 as another embodiment of the present invention, even when there is no workpiece-side protruding portion 42a, a compression portion of the present invention can be formed when a gap between a compression forming portion 42b of a workpiece body 42 and a second mold 30 is set to be smaller than a thickness of a sheet material 44 according to a place where a compression portion of the sheet material 44 is to be formed.

### REFERENCE SIGNS LIST

1 stacked workpiece molding device
2 clamp
20 first mold
20a mold-side protruding portion
22 suction hole
30 second mold
32 through hole
34 ejection hole
36 recessed portion
40 stacked workpiece
42 workpiece body
42a workpiece-side protruding portion
42b compression forming portion
44 sheet material
44a compression portion
51 first suction device
51 a first connection pipe
52 second suction device
52a second connection pipe
53 gas supply device
53a third connection pipe
53b bypass
54 flow channel switching valve
61 control unit
71 plate
100′ shutter device
X non-bonded region
Y bonded region

1. A stacked workpiece comprising:
a workpiece body; and
a sheet material stacked on the workpiece body, wherein
a compression portion crushed in a thickness direction is formed in at least a part of a peripheral portion of the sheet material.

2. The stacked workpiece according to claim 1, wherein
a workpiece-side protruding portion that protrudes toward a side of the sheet material and that is to form the compression portion is provided in the workpiece body. and
a protrusion amount of the workpiece-side protruding portion is set to be smaller than a thickness of the sheet material.
